(19) United States
(12) Patent Application Publication
(10) Pub. No.: US 2004/0104906 A1
(43) Pub. Date: Jun. 3, 2004

(54) Control chip and method of reducing electromagnetic interference

(76) Inventors: Jui-Feng Ko, Tainan (TW); Chih-Cheng Wei, Taipei City (TW)

Correspondence Address: J.C. Patents, Inc., Suite 250, 4 Venture, Irvine, CA, 92618, US

(21) Appl. No.: 10/701,261

(22) Filed: Nov. 3, 2003

(30) Foreign Application Priority Data
Nov. 12, 2002 (TW) 91133115

(51) Int. Cl. G09G 5/00

(52) U.S. Cl. 345/204

(57) ABSTRACT

A control chip and a method of reducing electromagnetic interference. The control chip for reducing electromagnetic interference is built inside an integrated circuit. An algorithm is downloaded from an external bus and stored inside the chip. The algorithm and an externally received clock signal are used to spread out the frequency of the electromagnetic interference signal. The clock signal is modulated through the algorithm so that electromagnetic interference signal at various frequencies is optimally process.

### CROSS-REFERENCE TO RELATED APPLICATION

This application claims the priority benefit of Taiwan application serial no. 91133115, filed on Nov. 12, 2002.

### BACKGROUND OF THE INVENTION

1. Field of Invention

The present invention relates to a control chip for reducing electromagnetic interference (EMI). More particularly, the present invention relates to a control chip that uses software phase lock loop (SPLL) to reduce electromagnetic interference.

2. Description of Related Art

Targeting the people in this multi-media society, semiconductor devices and display devices are developed at a rapid pace. In the field of display devices, cathode ray tube (CRT) has been used for quite some time but remains strong in the market due to its relatively high performance and low pricing. However, the demand for CRT is slowing down because of some environmental issues. In general, CRT consumes a lot of power and is relatively bulky. Hence, if one wants a display device with a high picture quality, a low power rating, a low driving voltage, a compact and slim body, a liquid crystal display (LCD) is the preferred device.

Back in the 1970s, liquid crystal displays are used in electronic calculators, clocks and watches. Thereafter, the discovery of various types of opto-electronic effects and improvements in driving techniques has lead to the production of high picture quality, low power rating, low voltage driven, slim and lightweight liquid crystal displays. At present, LCDs are used in various medium and small portable devices such as portable televisions, image phones, camcorders, notebook computers, desktop monitors and projection color televisions. Gradually, CRT is replaced. The most common present day LCD is the so-called thin film transistor liquid crystal display (TFT-LCD).

Among the panel of tests a TFT-LCD that needs to be conducted, tolerance against electromagnetic interference (EMI) is very important. If the peak value of some electromagnetic interference exceeds a permitted threshold, the TFT-LCD will fail the EMI test. Hence, to pass the EMI test, means are searched to reduce the peak value of electromagnetic disturbance so that it falls within the permitted tolerance level. At present, to reduce the effect of EMI on the TFT-LCD, an additional spread spectrum clock generator (SSCG) is installed in the driving circuit inside the application specific integrated circuit (ASIC) as shown in FIG. 1a. Alternatively, the ASIC may include a built-in SSCG as shown in FIG. 1b. The SSCG will spread out EMI signals according to the input clock signal so that interference by the electromagnetic signal is reduced.

FIG. 2a is a graph showing the spectral distribution of an electromagnetic interference signal. Assume that the originating frequency is f0 and width of the EMI signal is w0. After spreading out the EMI signal through the SSCG, the originating frequency is still f0 but the width has changed to w. The method of spreading by the SSCG includes using the pulse of an EMI as center to increase the pulse width of the EMI. According to the energy conservation principle, once the EMI pulse is spread out to a width w, peak value in dB has to drop. Hence, the frequency spectrum after spreading is changed to the one shown in FIG. 2b. Obviously, if the peak value (in dB) of the EMI signal is lowered to a value below a threshold of acceptance, the EMI signal no longer pose a problem to the TFT-LCD.

However, the conventional SSCG has some serious drawbacks. In general, a SSCG chip is able to spread out EMI signal at a specific frequency. In other words, the SSCG chip is incapable of spreading out EMI signals containing a spectrum of frequencies. Hence, as the frequency of the EMI signal is changed, the SSCG that has an effective spreading capability at a particular frequency is no longer suitable for reducing the EMI signal. Under such circumstances, the only way to spread out the EMI signal is to switch to another SSCG. That means, each EMI signal frequency requires a SSCG.

In brief, the conventional method of spreading EMI signal has the following disadvantages. An external SSCG chip or a built-in SSCG chip inside the ASIC chip is required. This often increases overall circuit complexity. Furthermore, a conventional SSCG only deals with EMI signal at a specified frequency with a fixed modulation. If there is any change to the EMI signal frequency, the already installed SSCG has no means of spreading out the shifted EMI signal. In other words, the SSCG is incapable of reducing EMI signals in a dynamic state.

### SUMMARY OF THE INVENTION

Accordingly, one object of the present invention is to provide a control chip that uses software to process a spectrum of electromagnetic interference signals and to spread out width of a frequency band so that sensed electromagnetic signals can be processed dynamically.

To achieve these and other advantages and in accordance with the purpose of the invention, as embodied and broadly described herein, the invention provides a control chip for reducing electromagnetic interference. The control chip is built inside an integrated circuit. Frequency of the electromagnetic signal is spread out according to an algorithm picked up from an external bus.

This invention also provides a control chip for reducing electromagnetic interference having a software phase lock loop built inside the chip. The software phase lock loop receives a clock signal and spreads out the frequency of the electromagnetic interference signal according to an algorithm. The software phase lock loop circuit inside the control chip is also connected to an external bus so that the algorithm can be fed into the phase lock loop circuit. The frequency of electromagnetic interference signal requiring treatment and the spreading width are set according to the algorithm sent to the software phase lock loop.

This invention also provides a method for reducing the strength of electromagnetic interference signals. The method includes the following steps. First, an algorithm is received. According to the algorithm, a specified frequency and corresponding spread out width for the electromagnetic interference signal are set. Using the specified frequency as a center, the electromagnetic interference signal is spread out to the preset width. In brief, this invention uses a software phase lock loop to receive a clock signal and an algorithm. The clock signal triggers the spreading of the electromagnetic interference signal. As the frequency of electromagnetic interference signal changes, the clock signal is modulated according to the algorithm. Thereafter, the modulated clock signal is used to spread out the changed electromagnetic interference signal. With this arrangement, this invention is able to track any frequency change in the electromagnetic interference signal and spread the signal out accordingly.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1a and 1b are block diagrams showing two types of conventional spread spectrum clock generator.

FIG. 2a is a graph showing the spectrum of an electromagnetic interference signal before a spreading treatment.

FIG. 2b is a graph showing the spectrum of an electromagnetic interference signal after a spreading treatment.

FIG. 3 is a block diagram showing a control chip for reducing electromagnetic interference according to one preferred embodiment of this invention.

FIG. 4 is a flow chart showing the steps for reducing electromagnetic interference according to this invention.

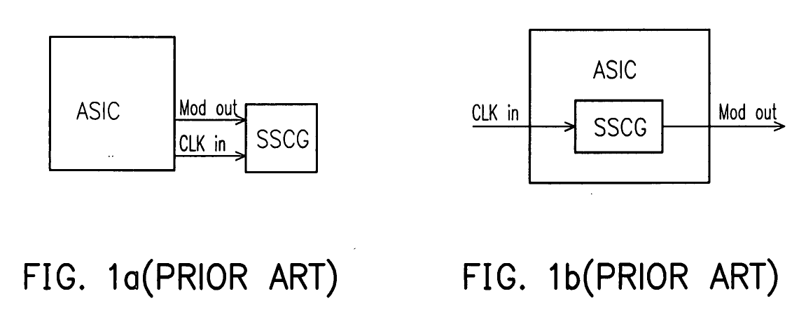

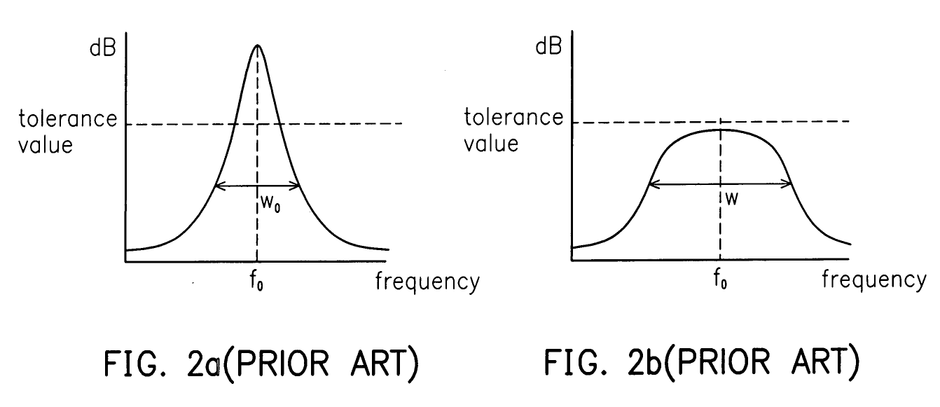

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

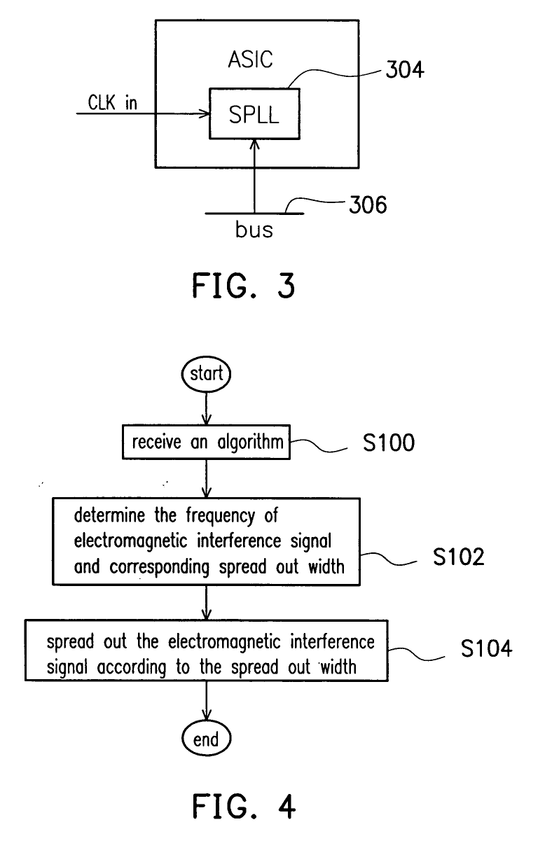

FIG. 3 is a block diagram showing a control chip for reducing electromagnetic interference according to one preferred embodiment of this invention. As shown in FIG. 3, the control chip 304 for reducing electromagnetic interference is built inside an integrated circuit 302. The control chip 304 receives an algorithm from an external bus 306 and stores up the algorithm internally. The control chip 304 also receives an external clock signal and spreads out the frequency of an electromagnetic interference signal according to the clock signal. The algorithm has the capacity to modulate the clock signal.

The aforementioned control chip can be a software phase lock loop (SPLL) and the integrated circuit can be an application specific integrated circuit (ASIC). According to this invention, even if the frequency of electromagnetic interference signal changes, the control chip 304 is still capable of spreading out the electromagnetic interference signal. The specified frequency of the electromagnetic interference signal and corresponding spread out width is set according to the algorithm. Hence, when the frequency of the electromagnetic interference signal changes, the algorithm is used to set the software phase lock loop 304 such that the central frequency of the electromagnetic interference signal as well as the degree of spreading in the electromagnetic interference signal are determined. The electromagnetic interference signal at each frequency are modulated according to a corresponding spread out width so that the peak values in dB of various electromagnetic interference signals are reduced.

FIG. 4 is a flow chart showing the steps for reducing electromagnetic interference according to this invention. First, in step S100, an algorithm is received. The algorithm is picked up from an external bus by the control chip as shown in FIG. 3. In step S102, a specified frequency and a spread out width for the electromagnetic interference signal are determined according to the algorithm. With this setup, the algorithm can be used to set up the software phase lock loop inside the control chip as shown in FIG. 3 when the frequency of the electromagnetic interference signal changes. Hence, the central frequency of the changed electromagnetic interference signal and the required spreading width are determined. The spread out width can be used to modulate the electromagnetic interference signal. Finally, in step S104, the electromagnetic interference signal is spread out around the specified central frequency.

In a conventional method of reducing electromagnetic interference, the spread spectrum clock generator (SSCG) is able to spread out the electromagnetic interference signal a specified frequency only. Once the electromagnetic interference signal changes, the SSCG is incapable of following the change and spread out the signal correspondingly. In other words, a given SSCG is incapable of spreading out electromagnetic interference signal other than the one designed for and hence another SSCG must be deployed to reduce a changed electromagnetic interference signal. In the invention, however, a built-in software phase lock loop inside an application specific integrated circuit is used to modulate a clock signal. The modulated clock signal is then used to spread out the electromagnetic interference signal. That means, as the frequency of the electromagnetic interference signal changes, the algorithm residing in the software phase lock loop is able to modulate the clock signal and spread out the electromagnetic interference appropriately. In this way, a corresponding clock signal is generated through the algorithm in the software phase lock loop whatever the frequency of incoming electromagnetic interference signal. Consequently, the control chip is able to reduced electromagnetic interference signals of whatever frequency.

In conclusion, major advantages of this invention includes:

1. No additional spread spectrum clock generators are required;

2. Modulation is set up by programming; and

3. The method provides an effective means of reducing electromagnetic interference signals of whatever frequency.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A control chip built inside an integrated circuit for reducing electromagnetic interference, wherein the control chip is able to spread out the frequency of an electromagnetic interference signal according to an algorithm.

2. The control chip of claim 1, wherein the control chip picks up the algorithm from an external bus.

3. A control chip for reducing electromagnetic interference, comprising:
a software phase lock loop built inside the control chip for receiving a clock signal and spreading out the frequency of an electromagnetic interference signal according to an algorithm; and
a bus coupled to the software phase lock loop for inputting the algorithm.

4. The control chip of claim 3, wherein the frequency of the electromagnetic interference signal and the spread out width at that frequency is set by the algorithm within the software phase lock loop.

5. An application specific integrated circuit for reducing electromagnetic interference, comprising:
a first input terminal for receiving a clock signal;
a second input terminal for receiving an algorithm; and
a software phase lock loop coupled to the first input terminal and the second input terminal for spreading out the frequency of an electromagnetic interference signal according to the clock signal and the algorithm.

6. The application specific integrated circuit of claim 5, wherein the frequency of the electromagnetic interference signal and the required spread out width at that frequency are set by the algorithm within the software phase lock loop.

7. A method of reducing the strength of an electromagnetic interference signal, comprising the steps of:
receiving an algorithm;
determining a specified frequency of the electromagnetic interference signal and a corresponding spread out width at that frequency according to the algorithm; and
spreading out the electromagnetic interference signal according to the spread out width using the specified frequency as the center of spreading.
